(19) United States
(12) Patent Application Publication
(10) Pub. No.: US 2009/0236477 A1
(43) Pub. Date: Sep. 24, 2009

(54) CABLE SUPPORT AND METHOD

(76) Inventor: Michael H.S. Oh, Twinsburg, OH (US)

Correspondence Address: Jonathan A. Platt;Renner, Otto, Boisselle & Sklar, LLP, 1621 Euclid Ave. - 19th Floor, Cleveland, OH, 44115, US

(21) Appl. No.: 12/403,746

(22) Filed: Mar. 13, 2009

Related U.S. Application Data
(60) Provisional application No. 61/037,406, filed on Mar. 18, 2008.

(51) Int. Cl. F16L 3/08

(52) U.S. Cl. 248/65

(57) ABSTRACT

A cable support includes a metal bracket having a bottom, and a stem and a tip extending from opposite sides of the bottom. The bracket may have in general a U shape (or a squared-off J shape), with a cable-receiving area between the stem and the tip. The support has one or more rollers between the bottom and the cable-receiving area, extending from the stem to the tip. The cable-receiving area has open sides at opposite ends, allowing the cable to be pulled through the cable-receiving area while resting on the one or more rollers. The support may be connected to other cable supports through a variety of mechanical mechanisms.

This application claims priority under 35 USC 119 to U.S. Provisional Application No. 61/037,406, filed Mar. 18, 2008, which is incorporated herein by reference in its entirety.

### BACKGROUND OF THE INVENTION

1. Technical Field of the Invention

The invention relates in general to cable supports/pullers and methods.

2. Description of the Related Art

U.S. Pat. No. 5,740,994 describes a variety of J-hook cable supports that are usable with high performance communications cable, as well as other types of cables. Such cable supports allow cables to be supported without constrictions on the cables, and without damage to the cables. Cable supports of this sort are available from ERICO International Corporation, of Solon, Ohio, USA.

Despite the benefits of J-hook cable supports previously available from ERICO International Corporation, improvements in this area are possible.

### SUMMARY OF THE INVENTION

According to an aspect of the invention, a cable support or puller includes many features that are an improvement over prior cable supports.

According to another aspect of the invention, a cable support or puller includes one or more rollers that support a cable in a cable-receiving area while the cable is pulled through the cable-receiving area. A retainer may be used to retain the cable in the cable-receiving area.

According to yet another aspect of the invention, a cable puller includes a bowed surface that keeps a cable run above a bottom of the cable puller.

According to still another aspect of the invention, a puller includes a metal bracket, and one or more plastic parts on the metal bracket.

According to a further aspect of the invention, a cable puller includes: a metal bracket that includes: a bottom; and a stem and a tip extending upward from opposite respective sides of the bottom, the stem and the tip defining a cable-receiving area between the stem and the tip; and one or more curved pieces that are mechanically coupled to the metal bracket and are located between the bottom and the cable-receiving area. The cable-receiving area has open ends that allow cable to be pulled through the cable-receiving area while in contact with the one or more curved pieces.

According to a still further aspect of the invention, a method of installing run of cable includes: placing a cable puller at one end of a series of cable supports, wherein the cable puller includes a metal bracket and one or more curved pieces that are mechanically coupled to the metal bracket and are located between a bottom of the metal bracket and a cable-receiving area of the metal bracket; and pulling the cable across the cable supports and through the cable-receiving area of the puller, with the cable not coming into contact with the bottom of the metal bracket.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings show embodiment(s) of the invention, which are not necessarily to scale.

FIG. 1 is an oblique view of a cable support/puller in accordance with an embodiment of the invention.

FIG. 2 is an oblique view of a bracket of the cable support/puller of FIG. 1.

FIG. 3 is a front view of the bracket of FIG. 2.

FIG. 4 is a side view of the bracket of FIG. 2.

FIG. 5 is a sectional view of the stem along the section 5-5 of FIG. 3.

FIG. 6 is an oblique view of a roller of the cable support/puller of FIG. 1.

FIG. 7 is an end view of the roller of FIG. 6.

FIG. 8 is a diagram illustrating the use of the cable support/puller of FIG. 1 to install a cable or cables on a series of cable supports.

FIG. 9 is an oblique view of a first type of coupling between a J-hook cable support and the cable support/puller of FIG. 1, using a tree bracket.

FIG. 10 is an oblique view of the universal tree bracket used in the coupling shown in FIG. 9.

FIG. 11 is an oblique view of a second type of coupling between a J-hook cable support and the cable support/puller of FIG. 1, using an angle bracket and a carabiner hook.

FIG. 12 is an oblique view of the angle bracket used in the coupling shown in FIG. 11.

FIG. 13 is a side view of the carabiner hook used in the coupling shown in FIG. 11.

FIG. 14 is an oblique view of a third type of coupling between a J-hook cable support and the cable support/puller of FIG. 1, using an angle bracket, a carabiner hook, and a link.

FIG. 15 shows the coupled cable support/puller and J-hook cable support of FIG. 16, supporting a cable (or cable run) making a substantially right angle turn.

FIG. 16 is a side view of the link used in the coupling of FIG. 14.

FIG. 17 is an oblique view of a cable support/puller of another embodiment of the present invention.

FIG. 18 is an oblique view of an insert of the cable support/puller of FIG. 17.

FIG. 19 is a bottom view of the insert of FIG. 18.

### DETAILED DESCRIPTION

A cable support includes a metal bracket having a bottom, and a stem and a tip extending from opposite sides of the bottom. The bracket may have in general a U shape (or a squared-off J shape), with a cable-receiving area between the stem and the tip. The support has one or more rollers between the bottom and the cable-receiving area, extending from the stem to the tip. The cable-receiving area has open sides at opposite ends, allowing the cable to be pulled through the cable-receiving area while resting on the one or more rollers. The support may be connected to other cable supports through a variety of mechanical mechanisms.

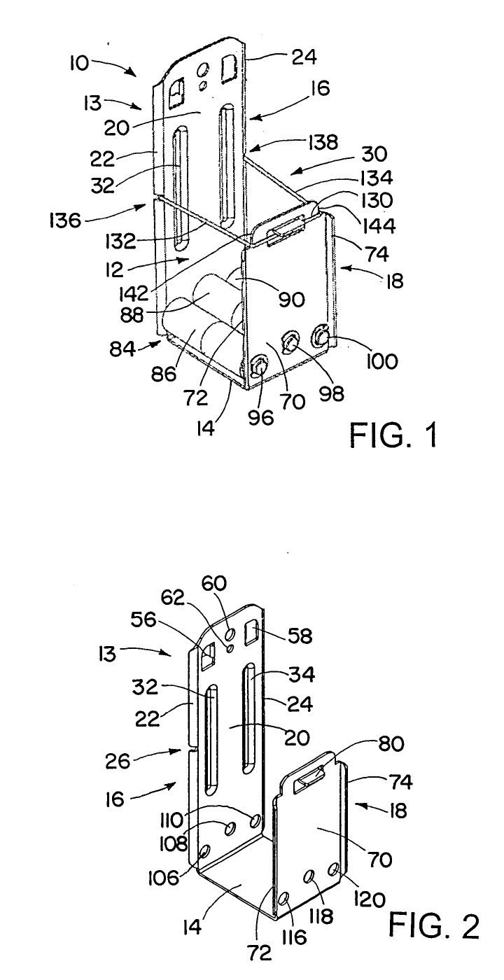

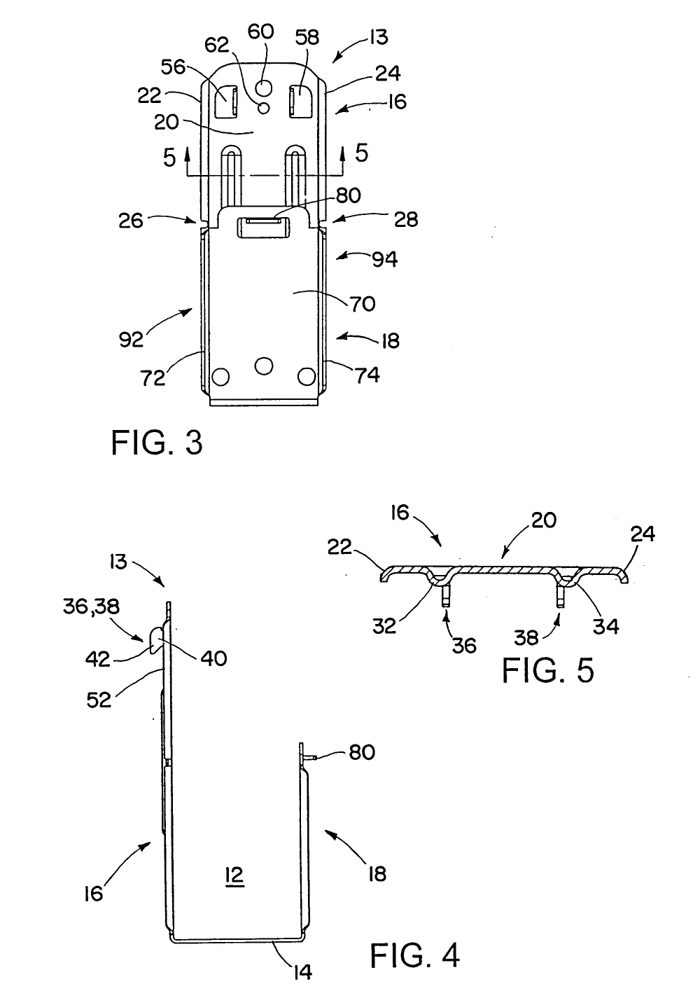

FIG. 1 shows a cable support 10 (also referred to as a “puller”) that allows pulling of cable through a cable-receiving area 12. Further referring to FIGS. 2-5, the cable support/puller 10 includes a metal bracket 13, for example made of steel, having a bottom 14, a stem 16, and a tip 18. The bottom 14 may be substantially planar, with the stem 16 and the tip 18 extending upward from opposite sides of the bottom 14. The stem 16 and the tip 18 may be substantially at right angles to the bottom 14. The stem 16 may extend to about twice the height of the tip 18 above the bottom 14, with the bracket 13 having a squared-off J-shape, alternatively describable as a U-shape with one of the upward arms partially removed.

The stem 16 has a flat central portion 20. On either side of the central portion 20 are angled flanges 22 and 24 that are bent back and angled away from the central portion 20. The stem 16 includes a pair of notches 26 and 28 in the stem flanges 22 and 24. The notches 26 and 28 are used for receiving and securing a wire retainer 30, as explained below.

The stem 16 has a pair of ribs 32 and 34 in a center part of the central portion 20. The ribs 32 and 34 are parallel to one another, oriented in a direction along the length of the stem 16 (the direction running from the root of the stem 16, where the stem 16 extends from the bottom 14, to the free end of the stem 16).

The stem 16 also has a pair of tabs 36 and 38. The tabs 36 and 38 protrude from the stem central portion 20. As explained in greater detail below, the tabs 36 and 38 are used to couple the stem 16 to one or more J-hooks and/or snap-on brackets, to couple multiple cable supports 10 together and/or to couple the cable support 10 to a structure member or surface.

The tabs 36 and 38 each have narrow neck 40 that broadens out into a broader body 42. On one side of the body 42 of each of the tabs 36 and 38 there is a sloped edge surface 44. The sloped edge surfaces 44 face toward the center of the stem 16, the portion of the stem 16 between the tabs 36 and 38, and the base of the stem 16 (where the stem 16 meets the bottom 14). On the other side of each tab body 42 (facing away from the center portion of the stem 16) there is a curved edge surface that leads to a step at the neck 40.

The tabs 36 and 38 may be bent portions of the sheet metal of the stem 16. The tabs 36 and 38 protrude rearward from the stem 16, from a back side 52 of the stem 16, away from the side that faces the cable-receiving area 12. The tabs 36 and 38 may thus leave corresponding holes 56 and 58 in the stem central portion 20.

The stem 16 may also have other holes for receiving fasteners. In the illustrated embodiment the fastener holes include a rivet hole 60 and a nail hole 62. The fastener holes 60 and 62 may be used to mechanically couple the stem 16 to structure and/or to other cable supports. The fastener holes 60 and 62 are centered in the stem central portion 20, in a vertical line, at different heights above the bracket bottom 14. It will be appreciated that different numbers of number, type, and/or configuration of fastener holes may be utilized instead. In addition, the holes 60 and/or 62 may be used for receiving hooks or other mechanical mechanisms, as described further below.

The tip 18 may be substantially parallel to the stem 16. Alternatively the tip 18 may be angled slightly away from the stem 16.

The tip 18, like the stem 16, includes a flat central tip portion 70, with flanges 72 and 74 angled away from the tip central portion 70. This provides the tip 18 with the same cable-friendly surface (no corners or sharp edges) as the stem 16.

The tip 18 also includes an outward-protruding tab 80 protruding away from the cable-receiving area 12. The tab 80 is used to aid in retaining the wire retainer 30, as discussed further below.

A set of rollers 84 is at the bottom of the cable-receiving area 12, between the cable-receiving area 12 and the bracket bottom 14. The set 84 may include three rollers 86-90, with the middle roller 88 higher above the bottom 14 than the side rollers 86 and 90. The rollers 86-90 extend from the stem 16 to the tip 18, and may be substantially perpendicular to the stem 16 and the tip 18. The rollers 86-90 turn as cable is pulled across them from an open end 92 on one side of the cable-receiving area 12, to an open end 94 on the opposite side of the cable-receiving 12. The configuration of the rollers 86-90, with the middle roller 88 above the side or end rollers 86 and 90, provides a bowed cable-engaging surface that keeps the cable away from the bracket 13 and from other cable supports that may be spaced apart in series, allowing easy pulling of cables across a series of cable supports that support a run of cable.

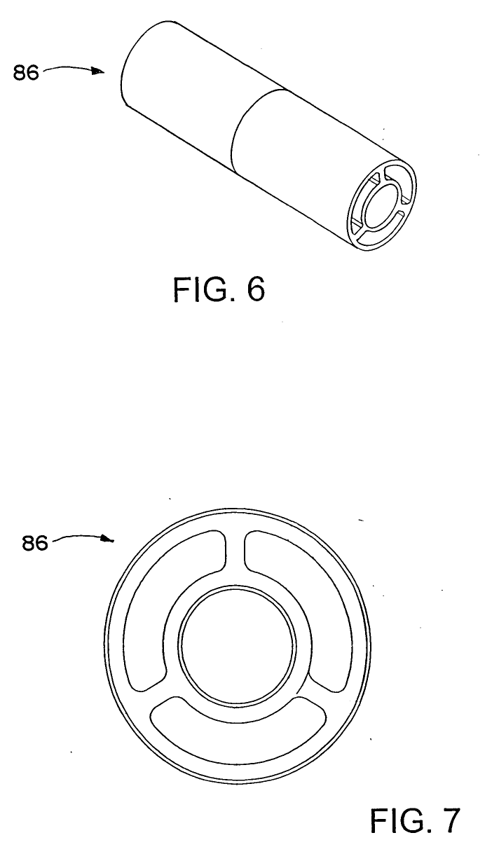

The rollers 86-90 are mounted on and rotate about respective pins 96, 98, and 100. The pins 96, 98, and 100, are inserted in stem holes 106, 108, and 110 in the stem 16, and in corresponding tip holes 116, 118, and 120 in the tip 18. With reference in addition to FIGS. 6 and 7, the rollers 86-90 may be made of suitable molded plastic, and may have hollows to receive the pins 96-100, and to reduce weight and material usage.

The stem 16 and the tip 18 together define the cable-receiving area 12 between them. The cable-receiving area 12 is above the roller set 84 and below the free end at the top of the tip 18.

The wire retainer 30 has a rectangular shape, with a central portion 130, a pair of legs 132 and 134, and a pair of bent ends 136 and 138. The legs 132 and 134 are substantially parallel to one another, and are at substantially right angles to the central portion 130. The bent ends 136 and 138 are bent inward at distal ends of the legs 132 and 134, farthest from the central portion 130. The bent ends 136 and 138 are bent inward toward a centerline of the wire retainer 30. The retainer 30 may be made from a single piece of wire, bent to form the various parts 130-138.

When the retainer 30 is installed, the retainer central portion 130 is held in place by the tab 80 of the tip 18. The retainer legs 132 and 134 extend around tip edges 142 and 144 of the tip 18. The bent ends 136 and 138 of the retainer 30 fit into and are retained by the notches 26 and 28 in the stem 16. The wire formed cable retainer 30 allows easier cable retainer assembly and disassembly in the field compared to the existing plastic retainer (see FIG. 1).

Newer high performance cables having larger cable diameters require larger cable bend radius (four times of cable diameter) per IEEE and TIA Standards. The manufacturing of the high performance J-hook such as ERICO's CAT32HP is very difficult even though the most expensive and most complex progressive die is used. The pulling hook 10 (also referred to herein as a puller) with the three plastic rollers 86-90 or with (as described below) a single plastic insert can be used to meet the cable bend radius requirement as well (as discussed below). The puller 10 can be made by use of a simple forming die, without requiring any special skills.

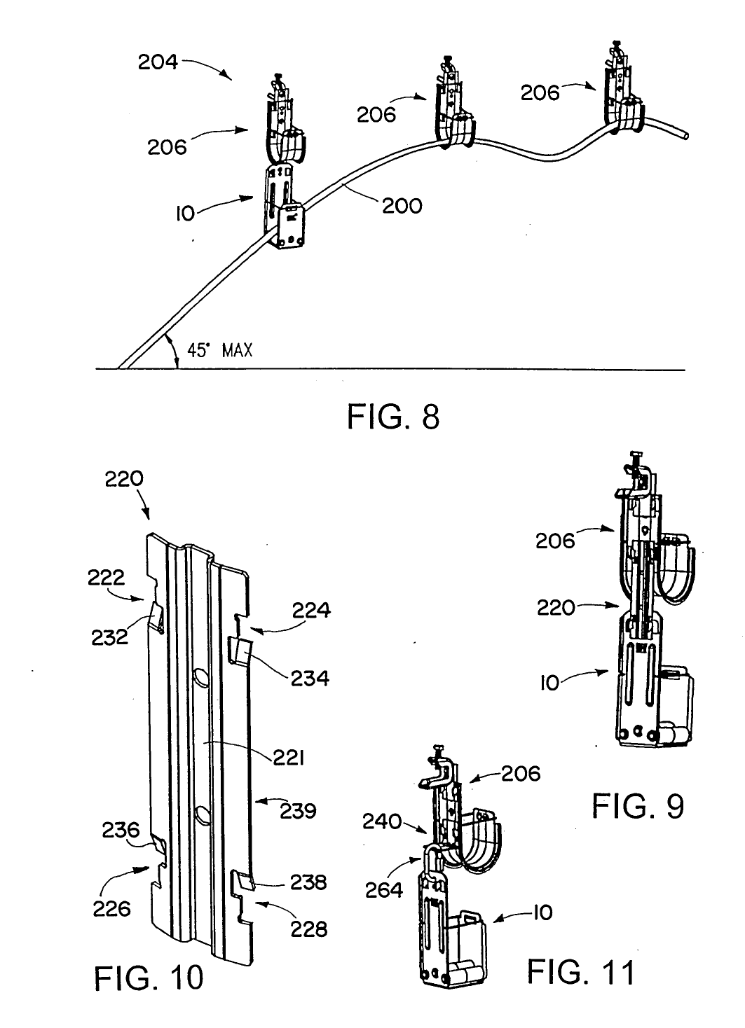

With reference now in addition to FIG. 8, the puller 10 may be used to support cable 200 while pulling the cable or cables 200 along a series of cable supports 204. Cable pullers 10 may be used at three places when pulling cables through J-hooks: at a start position, at 90-degree corners, and at a finish position. Other cable supports 206 in the series may have a different configuration, without the rollers 86-90 or other puller mechanisms. The cable supports in the cable support series 204 may be secured to building structure, such as walls or other structural elements, either directly or indirectly, for example through use of any of a variety of suitable clips or clamps. The connection to building structure may be made by coupling supports or pullers to other supports or pullers that are in turn secured to building structure. The connection of cable supports to the building structure may be accomplished by any of a variety of suitable mechanisms. Examples include use of a suitable fastener, such as a rivet, nail, or screw, and use of an intervening clamp, such as a purlin or beam clamp that clamps on the flange of a purlin or beam. Such as clamps are well described in prior co-owned patents and patent applications. Examples of cable support configurations for the cable supports 206, and for devices for securing supports and pullers to building structure, are described in co-owned U.S. patent application Ser. No. 12/196,315, filed Aug. 22, 2008 (attorney docket ERICPO371USA), the description and figures of which are incorporated herein by reference.

The cable puller 10 may be used to pull the cable 200 downward, for example at an angle of 45 degrees or greater to the horizontal, with the cable 200 in contact with only the rollers 86-90 (with no contact with any part of the bottom 14). The ability to use a downward pulling direction may facilitate use with the puller 10 coupled below a cable support 206, and/or may facilitate use in an overhead run of cable(s).

After pulling the cable 200 across the cable support series 204 the cable puller(s) 10 may be disengaged from the installation, with the cable 200 in the final installation supported only by the supports 206. Prior to disengagement the cable may be lifted by the installer from the cable puller(s) 10 and placed into cable-receiving area(s) of respective cable support(s), for example the cable support(s) that the disengaged puller(s) were connected to. Alternatively, the puller 10 with the three plastic rollers 86-90 can be also used as a cable guide or cable support in the final cable installation.

Referring now in addition to FIGS. 9 and 10, a quick snap-on universal tree mounting bracket 220 may be used to enable easier tree installation of the puller 10. The two tree mounting tabs 36 and 38 (FIG. 5) located on the flat backbone (stem) 16 of the puller 10 are similar to those on the curved backbone (stem) 221 of high performance J-hook cable support 206 (FIG. 8). The tree mounting bracket 220 has a generally rectangular shape, with four notches 222, 224, 226, and 228 for receiving and securing pairs of stem tabs of the cable supports 10 and/or 206, in order to secure multiple of the cable supports 10 and/or 206 together. The notches 222-228 are in two sets, located at different distances along the bracket 220. Tabs 232, 234, 236, and 238 extend at an angle to the body 239 of the mounting bracket 220, adjacent to the respective notches 222-228. The tabs 232-238 are located adjacent to the notches 222-228, at the ends of the notches 222-228 closest to the center of the mounting bracket 220. The tabs 232-238 aid in maintaining the stem tabs in the notches 222-228. The bracket 220 may be made from spring steel or another suitable material. Further details regarding the bracket 220 may be found in U.S. patent application Ser. No. 12/196,315.

The tabs 36 and 38 of the puller 10 may engage the notches 222-228 and the tabs 232-238 of the mounting bracket 220. The tabs 36 and 38 allow the puller 10 to snap on to the bracket 220, easily securing the puller 10 to the bracket 220.

The cable puller 10 may be installed below the high performance J-hook cable support 206 by any of a variety of different methods or mechanisms. Cable pullers 10 may be used at three places when pulling cables through J-hooks 206: at a start position, at 90-degree corners, and at a finish position. For the start and finish positions, two mounting methods may be used. The tree-mounting bracket 220 may be used to connect J-hook 206 and the puller 10 (FIG. 9), as described above. The quick-snap-on tree mounting bracket 220 enables easier cable puller 10 installation onto the high performance J-hook 206 (mechanically coupling the puller 10 and the cable support 206 together) in the field without any additional hardware (FIGS. 8 and 9).

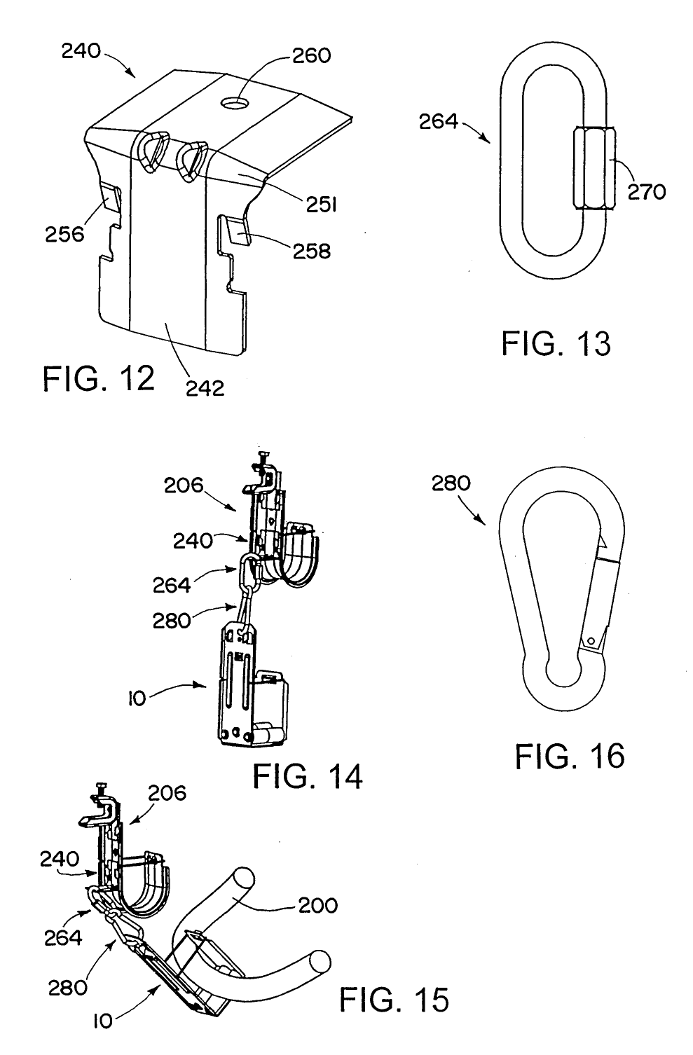

Alternatively, with reference to FIGS. 11 and 12, an angle bracket 240 may be used to connect the J-hook 206 and puller 10. The angle bracket 240 may be coupled to the cable support 206 (FIG. 11). The bracket 240 has a bracket body 242 that has a substantially right-angle bend 251 bisecting it along its length. It will be appreciated that the bracket 240 may alternatively have a bend of a different extent. On one side of the bend 251 the bracket 240 has a pair of notches 252 and 254 that have respective angled tabs 256 and 258 adjoining them. The notches 252 and 254 and the tabs 256 and 258 may be substantially identical in configuration and function to the notches 222-228 and the tabs 232-238 of the bracket 220 (FIG. 10). One the other side of the bend 251 the bracket 240 has a hole 260. The hole 260 may be used to receive a rivet, threaded fastener, or other fastener, usable to secure the bracket 200 to a structural member or to a mounting clip or clamp. Further details regarding the angle bracket 240 may be found in U.S. patent application Ser. No. 12/196,315.

A carabiner hook 264 (FIGS. 11 and 13) may be used couple the puller 10 to the angle bracket 240. A gate 270 of the carabiner hook 264 may be opened to allow the carabiner hook 264 to pass through the angle bracket hole 260 and the puller stem hole 60. The carabiner hook 264 may be a screw-gate carabiner hook, with the gate 270 being an internally-threaded sleeve that threads onto a threaded section of the carabiner hook 264 in order to close the carabiner hook 264. Alternatively the carabiner hook 264 may have a different type of closure, for example having a spring gate that automatically closes when no force is put on it to maintain it open.

For 90-degree corner turns, the angle bracket 240 and the carabiner hook 264 may be supplemented by a link 280 also used in connecting the J-hook 206 and the puller 10 (FIGS. 14-16). Such a substantial right angle turn may occur in the middle or intermediate position of an intended cable run, with other cable supports and/or cable support/pullers on either side of the puller 10, both upstream and downstream of the puller 10. The angle bracket 240 may couple to the J-hook cable support 206, the carabiner hook 264 may couple the link 280 to the angle bracket 240, and the link 280 may couple the puller 10 to the carabiner hook 264. The link 280 may be a spring-gate clip or carabiner hook, or other type of mechanical linkage.

The quick snap-on angle bracket 240 and the carabiner hook 264 and/or the link 280 enable easier cable puller installation onto the high performance J-hook 206 in the field without any additional hardware for the cable-pull-through J-hooks 10 at start and finish positions. Following the installation the cable may be lifted from the puller 10 to be placed in the J-hook cable support 206. Then the support/puller 10 may be decoupled from the cable support 206 and used again at a puller in another location or in another installation.

The cable hooks described herein may be any of a variety of sizes, such as 2.5 cm (1 inch) through 10 cm (4 inch) sizes. The hooks provide non-continuous support for high performance cables.

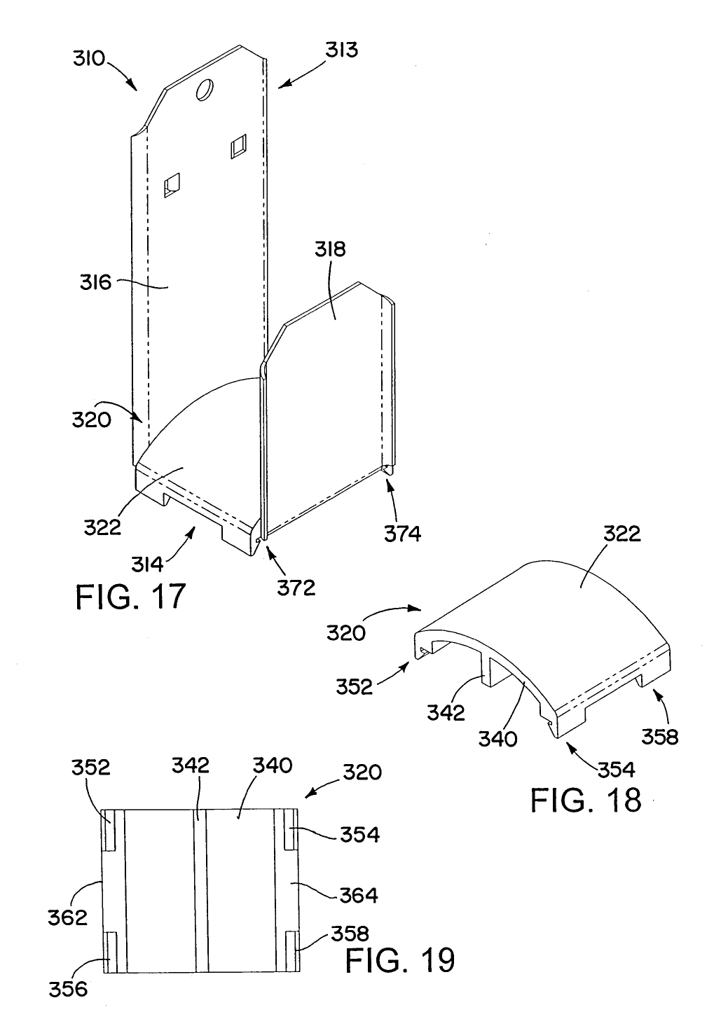

Turning now to FIG. 17, a cable support or puller 310 has a metal bracket 313, and an insert 320 that fits onto a bottom 314 of the metal bracket 313. The bracket 313 may be similar in configuration to (and indeed may be substantially identical to) the metal bracket 13 of the support or puller 10 (FIG. 1), with a stem 316 and a tip 318 extending upward from opposite sides of the flat bottom 314. Other features of the bracket 313 may be similar to corresponding features of the bracket 13.

The insert 320 is a plastic piece that is inserted between the stem 316 and the tip 318, coupling onto the bottom 314. The plastic insert 320 has a curved upper surface 322 that facilitates pulling of cables across it, through a cable-receiving area 312 above the insert 320 and between the stem 316 and the tip 318.

With reference in addition to FIGS. 18 and 19, the insert 320 has a curved body 340 with a central strut 342 underneath the center part of the body 340. The strut 342 provides support for the raised body center part when the insert is installed onto the bracket bottom 314. The insert 320 has four downward-extending hooks 352, 354, 356, and 358, two on each of opposite edges 362 and 364 of the curved body 340. The edges 362 and 364 are at either side of the strut 342, running roughly parallel to the strut 342. The hooks 352-358 have sloped inner surfaces facing inward toward the center strut 342. As the insert 320 is pushed down against bottom 314, edges 372 and 374 of the bottom 314 press against the sloped surfaces of hooks 352-358, resiliently deforming the hooks 352-358 outward. With continued pushing the edges 372 and 374 pass the ends of the sloped surfaces and snap inward, holding the insert 320 against the bracket bottom 314.

The puller 310 may be combined with other cable supports in ways similar to the cable support or puller 10, as described above.

The puller 310 advantageously has a metal bracket 313 that provides good structural integrity. The plastic insert 320 provides the curved upper surface 322 that allows cable to be pulled through the cable-receiving area 312 with low friction.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A cable puller comprising:
a metal bracket that includes:
a bottom; and
a stem and a tip extending upward from opposite respective sides of the bottom, the stem and the tip defining a cable-receiving area between the stem and the tip; and
one or more curved pieces that are mechanically coupled to the metal bracket and are located between the bottom and the cable-receiving area;
wherein the cable-receiving area has open ends that allow cable to be pulled through the cable-receiving area while in contact with the one or more curved pieces.

2. The cable puller of claim 1, wherein the one or more curved pieces includes rollers having axes that extend from the stem to the tip.

3. The cable puller of claim 2, wherein one of the rollers has a different height above the bottom than another of the rollers.

4. The cable puller of claim 2,
wherein the rollers are mounted on respective pins that extend from the stem to the tip;
wherein the pins are located in corresponding sets of holes in the stem and the tip; and
wherein the pins are located in central holes running along the axes of the rollers.

5. The cable puller of claim 1, wherein the one or more curved pieces includes a plastic insert that has a curved upper surface, and that snaps onto the bracket bottom.

6. The cable puller of claim 1, wherein the metal bracket has a squared-off J shape, with the stem and the tip extending substantially at right angles to the bottom.

7. The cable puller of claim 1, wherein the stem has multiple fasteners holes therein of different sizes.

8. The cable puller of claim 1, wherein the stem has vertical strengthening ribs therein.

9. The cable puller of claim 1, wherein the stem has a pair of tabs extending from a back face of the stem.

10. A method of installing run of cable, the method comprising:
placing a cable puller at one end of a series of cable supports, wherein the cable puller includes a metal bracket and one or more curved pieces that are mechanically coupled to the metal bracket and are located between a bottom of the metal bracket and a cable-receiving area of the metal bracket; and
pulling the cable across the cable supports and through the cable-receiving area of the puller, with the cable not coming into contact with the bottom of the metal bracket.

11. The method of claim 10, wherein the placing the cable puller includes mechanically coupling the puller below an additional cable support that is coupled to building structure.

12. The method of claim 11, wherein the mechanically coupling includes coupling a bracket to back sides of stems of both the cable puller and the additional cable support.

13. The method of claim 11 wherein the mechanically coupling includes coupling an angle bracket to a back side of a stem of the additional cable support, and using a carabiner hook to couple the angle bracket to the puller.

14. The method of claim 13 wherein the mechanically coupling further includes using an additional link between the angle bracket and the puller, to aid in coupling the puller to the angle bracket.

15. The method of claim 10,
wherein the metal bracket of the cable puller has a squared-off J shape, with the stem and the tip extending substantially at right angles to the bottom; and
wherein the cable-receiving area is between the stem and the tip, above the one or more curved pieces.

16. The method of claim 15,
wherein the one or more curved pieces includes rollers having axes that extend from the stem to the tip; and
wherein pulling includes rotating the at least some of the rollers.

17. The method of claim 16, wherein one of the rollers has a different height above the bottom than another of the rollers.

18. The method of claim 10,
wherein the one or more curved pieces includes a plastic insert that has a curved upper surface, and that snaps onto the bracket bottom; and
wherein the pulling includes sliding the cable run along the curved upper surface.

19. The method of claim 10, wherein the pulling includes downward pulling of the cable run in a direction angled toward the bottom of the bracket.

20. The method of claim 10,
wherein the cable run makes a substantial right angle turn during the pulling; and
further comprising, prior to the pulling, placing an additional cable puller at a location where the substantial right angle turn takes place.
